(19) United States
(12) Patent Application Publication
(10) Pub. No.: US 2012/0224913 A1
(43) Pub. Date: Sep. 6, 2012

(54) PUSH/PULL ROD

(75) Inventor: Matthias Haller, Schoerfling a. Attersee (AT)

(73) Assignee: RO-RA PRODUKTIONS GMBH, Schoerfling a. Attersee (AT)

(21) Appl. No.: 13/508,836

(22) PCT Filed: Nov. 10, 2010
(86) PCT No.: PCT/DE2010/075128

§ 371 Date: May 9, 2012

(30) Foreign Application Priority Data
Nov. 10, 2009 (AT) A 1781/2009
Jul. 13, 2010 (EP) EP 10 169 361.2
Oct. 21, 2010 (DE) 20 2010 008 858.5

(51) Int. Cl. F16G 11/12

(52) U.S. Cl. 403/46

(57) ABSTRACT

The invention relates to a push/pull rod (1), comprising at least one fastening device (2, 3), a connecting piece (4) having end faces (16, 17) distanced from each other in the axial direction, and a locking device (5) having first and second locking elements (10, 11) that face each other when viewed in the axial direction and that interact and that are pressed against each other by means of a spring element (12). The spring element (12) is supported at the first end (22) thereof on a support shoulder (23) formed on the connecting piece (4) and at the second end (24) thereof on the second locking element (11). The rotational motion of the fastening device (2) relative to the connecting piece (4) is releasably blocked at a predetermined locking force by the locking elements (10, 11) in a plurality of rotational positions.

The invention relates to a push-pull rod as described in the preamble of claim 1 or of claim 2.

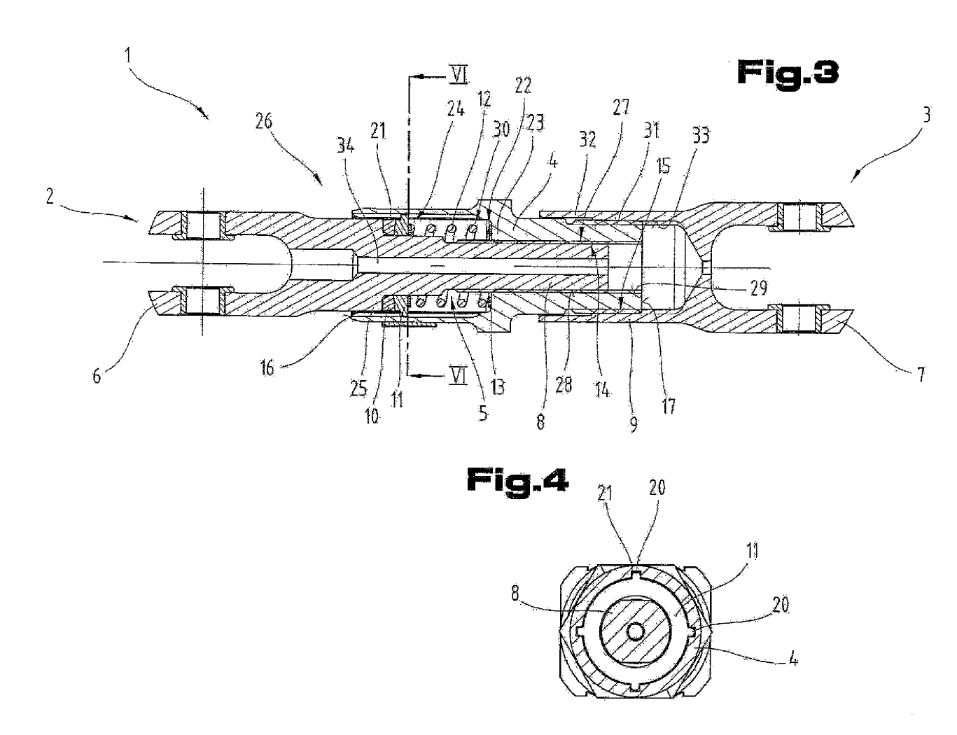

GB 0 524 717 A discloses a push-pull rod which, as per the illustration in FIG. 3, has a central mid-part with internal threads, and in each case one threaded shank with a coupling element arranged thereon and connected thereto is screwed in from both ends which are at a distance from one another in the axial direction. Of the thread arrangements which interact with one another in each case, one is formed as a left-hand thread and one is formed as a right-hand thread. Furthermore, the central mid-part is in each case surrounded in regions by a tubular sleeve which is arranged on the coupling elements, in order thereby to prevent an ingress of dirt or contaminants into the thread arrangements. Provided on each of the two shank ends is a separate detent device which in turn comprises first and second detent elements, which in each case face toward and interact with one another in the axial direction, and a spring element. The spring element is supported, at the shank end, on a disk specially to be mounted, and pushes the two detent elements against one another in the axial direction. Here, the detent elements are formed by teeth which are directed toward one another in the axial direction. The first detent element is formed in one piece with the shank and the second element is coupled in a rotationally conjoint manner to the central mid-part. For this purpose, the latter has a groove which extends in the axial direction and into which engages a sliding block which is formed on the detent element.

Another push-pull rod, formed as a hanging element, is known from EP 1 588 975 A2. Said hanging element comprises two fastening elements which have in each case one shank, wherein at least one shank has a thread. Furthermore, the hanging element comprises a central element which has a threaded sleeve in at least one of the end surfaces and into which the fastening elements engage at the opposite end surfaces. At least one of the shanks which have a thread is provided, at its end surface, with a toothed washer with radially running teeth which engage into radially running teeth arranged on the end surface of the counterpart toothed washer. The counterpart toothed washer is acted on on its rear surface by a spring element. For rotational locking of the two toothed washers with respect to one another, a separate guide sleeve is inserted in the central element, which guide sleeve has an axial passage opening with a polygonal inner contour. On the rear surface of the counterpart toothed disk there is furthermore arranged a polygonal shank, wherein the latter engages into the axial passage opening of the guide sleeve and is displaceable therein.

Another push-pull rod is known from WO 2006/042750 A1. The push rod comprises a central body with at least one adapter for mounting the push-pull rod, wherein for variation of the length of the push-pull rod, the adapter is rotatably connected to the body via a thread arrangement. Furthermore, a detent device is provided which acts on the rotational movement in such a way as to releasably latch it in a multiplicity of rotational positions with a predeterminable locking force. The detent device has two detent elements, wherein the first detent element is arranged on the adapter and the second detent element is arranged on the body. The first detent element has at least one detent lug by means of which it engages, in order to latch the detent device, into the second detent element. The second detent element is in the form of a toothed ring into which the first detent element engages in a resilient manner with its detent lug, and exerts a force thereon.

It is the object of the present invention to provide a push-pull rod which is of compact, simple modular design and which can be operated without the aid of a tool, with an inadvertent change in length in the installed state thereof being prevented.

Said object of the invention is achieved by means of the features of claim 1 or of claim 2. The advantage arising from the features of claim 1 or of claim 2 lies in the fact that, as a result of the compact structural unit composed of the fastening device, the connection piece and the detent device arranged in between, not only is bracing of the two detent elements against one another in the axial direction attained, but furthermore also as a result of the support of the spring element against the support shoulder of the connection piece, it is possible to attain bracing of the two interacting threads with respect to one another between the shank of the fastening device and the connection piece. It is thus possible in this way for alternating loads on the push-pull rod in the axial direction with corresponding selection of the spring force, and the associated noises and unpleasant knocking or impacting, to be prevented. Furthermore, as a result of the loose arrangement of the spring element and of at least one of the two interacting detent elements on the shank of the fastening device, an assembly is created which can be joined without the use of additional tools, in which assembly only the connection piece for receiving the shank thread can be assembled with the fastening device after the threading-on of at least one detent element and of the spring element. In this way, it is also made possible, in the event of intense wear or a spring failure, for the damaged or worn components to be replaced rapidly and without the aid of additional tools.

In a further advantageous embodiment, the connection piece, the first fastening device and the detent device form a common, coherent assembly. In this way, a preassembled coherent assembly can be provided which, depending on the further application, may be combined as desired with other structural elements. In this way, a component group can be provided to which, in one case, a further fastening device is connected directly or, in another case, an additional central part or central piece is connected. In this way, a modular design is attained which permits high flexibility with a low stock-keeping requirement.

In one advantageous embodiment, a thread of the thread arrangement is formed at least on an end portion, which is at a distance from the coupling element, of the shank, and a further thread is formed, on that side of the support shoulder which faces away from the detent device, in the connection piece, and the detent device is arranged between the support shoulder and the coupling element. Said embodiment is advantageous because, in this way, the detent elements can be pressed against one another by means of the spring element without additional components and without the need for additional assembly outlay. Depending on the selected length of the spring element, it is possible for the latter to be threaded onto the shank together with the one or more detent elements, and thereafter for only the shank to be screwed into the thread provided in the connection piece.

In a further advantageous embodiment, the thread of the shank is formed as an external thread and the thread of the connection piece is formed as an internal thread. As a result of said design it is possible, with an extremely small spatial requirement, to provide a compact structural unit and to nevertheless permit an adjustment of the connection piece and of the fastening device with respect to one another.

In another advantageous design variant, the connection piece has, on its side facing toward the coupling element, a receiving space for receiving the detent device. In this way, the detent device is protected against contamination, wherein furthermore, latching of a detent element and the connection piece with respect to one another is possible. Furthermore, it is also possible in this way for space to be provided for the actuation of the connection piece or else for the mounting of additional locking elements or the like.

Also advantageous is a refinement in which the connection piece, by means of that face end which faces toward the coupling element, engages over the detent device in the direction of the coupling element, because in this way even better protection of the detent device against the ingress of dirt or contaminants can be attained. It is however likewise possible in this way for an egress of lubricant or the like, which is possibly applied to the detent device, to be prevented.

In the case of the embodiment according to claim 3, it is advantageous that, in this way, simple and cheap production of the detent element is made possible which can take place independently of the design of the coupling element of the fastening device. It is thus possible for mutually separate production to take place. It is thus then possible for the interacting detent elements to be adapted in a simple manner to different usage conditions.

By means of the refinement according to claim 4, it is attained that, here, a simple design of the detent element is provided, which detent element can be produced independently of the further components of the assembly and must merely be correspondingly selected for the assembly process.

By means of the refinement according to claim 5, a simple rotationally conjoint connection can be created, wherein merely an insertion of the one or more projections on the detent element into the recess or recesses in the connection piece is necessary here. An inherently compact structural unit is thus provided in which a high degree of flexibility and simple exchangeability of individual components is permitted.

Also advantageous is an embodiment according to claim 6, because it permits, with relatively short structural lengths, the connection of a further fastening device, wherein, then, an overlapping of the two thread arrangements as viewed in the axial direction leads to an additional component shortening.

According to an embodiment as described in claim 7, the coupling of the fastening device to the connection piece is provided in the region of the connection piece in an overlapping manner. It is thus possible even with an adequately long adjustment travel to attain a relatively short overall structural length.

In a further advantageous embodiment, one of the two threads of the connection piece for connecting to one of the two fastening devices is formed as a right-hand thread, and the other thread is formed as a left-hand thread. Here, said design has proven to be particularly advantageous because, in this way, a displacement of the two fastening devices in opposite directions to one another relative to the connection piece can be attained in a simple manner and with an extremely short axial extent.

One advantageous refinement as per claim 8 permits the integration of the common assembly in a push-pull rod, and thus makes it possible to carry out a simple adaptation to different installation lengths. The advantage of said simple length adaptation is thus provided together with the advantage of the simple rotational locking.

An embodiment is however also possible in which the further fastening device is connected to the other end of the central part with the interposition of an intermediate piece. In this way, a single central part with uniform dimension can suffice, wherein then, depending on the level of force to be transmitted, the dimensions of the fastening devices can be maintained, with the corresponding adaptation to the forces to be transmitted being carried out merely in the region of the central part. It is possible here in particular for buckling loading to be allowed for more effectively.

In a further advantageous embodiment, the shank of the first fastening device protrudes through that face end of the connection piece which faces away from the first coupling element, and at least one radially protruding stop element is arranged on one shank end and connected to the shank. In said advantageous embodiment, at least one of the fastening devices is prevented from being completely unscrewed from the connection piece, and thus complete disassembly is prevented in good time.

In a further advantageous embodiment, the relative adjustment of the connection piece or of the central part with respect to the two fastening devices takes place in a continuously variable fashion. In this way, during the relative displacement even over the smallest distances, a precise adjustment of the overall length is possible and nevertheless rotational locking against inadvertent release can be attained.

In a further advantageous embodiment, the further fastening device has, on its end facing toward the intermediate piece, an external thread which is rotatably connected to an internal thread formed on the intermediate piece. Here, the two threads form a further thread arrangement. Here, the external thread is particularly advantageously formed on a shank of the further fastening device.

The external thread of the further fastening device is preferably formed along the further fastening device in the axial direction of the push-pull rod over a region longer than that over which the thread arrangement is formed along the first fastening device.

In a further advantageous embodiment, the further fastening device is formed so as to be longer in the axial direction of the push-pull rod than the first fastening device.

As a result of said elongated form of the thread arrangement of the further fastening device or of the fastening device itself, the adjustment travel of the push-pull rod is increased. Said lengthened adjustment travel in turn leads to a reduction in variant diversity. As a result of the large adjustment travel, it is possible for relatively short or relatively long push-pull rods to be replaced. It is also possible in this way for greater tolerances to be compensated.

The shank of the further fastening device advantageously protrudes through that face end of the intermediate piece which faces away from the second coupling element, and at least one radially protruding stop element is arranged on one shank end and connected to the shank. In this way, the further fastening device is prevented from being completely unscrewed from the intermediate piece, and thus complete disassembly is prevented in good time.

As per the advantageous embodiment according to claim 16, the connection piece has, on its side facing away from the coupling element, a receiving space which serves for receiving the detent device and which is delimited, on its side facing away from the coupling element, by a support shoulder, which is formed as a support ring, for supporting the first end of the spring element. In this way, the detent device is protected against contamination, wherein furthermore, latching of a detent element and the connection piece with respect to one another is possible. Furthermore, it is possible in this way for space to be provided for the actuation of the connection piece or else also for the retention of additional locking elements or the like.

As per the advantageous embodiment according to claim 17, the shank has, on its side facing away from the coupling element, a profiled shank projection, by means of the profiling of which the second detent element is mounted in a rotationally conjoint and axially displaceable manner on the connection piece. In this way, it is possible to realize reliable rotationally conjoint mounting, which is simple to produce, with simultaneous displaceability of the second detent element along the axial direction of the shank.

In the further advantageous embodiment as per claim 18, the shank, in particular the profiled shank projection, protrudes through the receiving space of the connection piece, and at least one radially projecting stop element is arranged on the shank end of said shank.

Stable guidance of the second detent element and/or of the spring element is possible in this way.

As per the advantageous embodiment described in claim 19, the first detent element is formed in one piece with the connection piece, in particular as an internal shaft shoulder. In this way, the first detent element can be rotationally conjointly connected to the connection piece in a particularly secure manner. Furthermore, the ease of assembly of the push-pull rod is increased owing to the reduced number of parts.

In the advantageous embodiment described in claim 20, the support ring is connected by means of an adhesive or snap-action connection to that axial end region of the connection piece which faces away from the coupling element. This permits a particularly reliable and assembly-friendly connection of the coupling element to the support ring.

In the advantageous embodiment described in claim 21, the push-pull rod has a snap-action bolt which can be attached to the coupling element and which has a metallic pin and which also has a lever arm and snap-action ring composed in each case of plastic, in particular polyamide. The snap-action bolt can, in order to secure the connection, be mounted with the pin into the eyelets of the coupling element and with the snap-action ring around the connection piece. The embodiment as a two-component part (metal and plastic) makes it possible to realize firstly a reliable, durable bolt and at the same time a snap-action ring with good resilient properties.

In the advantageous embodiment described in claim 22, the pin has, on one of its axial end regions, an undercut and a flattening. This permits a particularly secure and rotationally conjoint connection between the pin and lever arm.

In a further advantageous embodiment of the push-pull rod, the shank of the first fastening device and/or the shank of the further fastening device has an internal bore which extends along the axial direction of the push-pull rod.

For better understanding of the invention, the invention will be explained in more detail on the basis of the following figures, in which, in a highly schematic simplified illustration in each case:

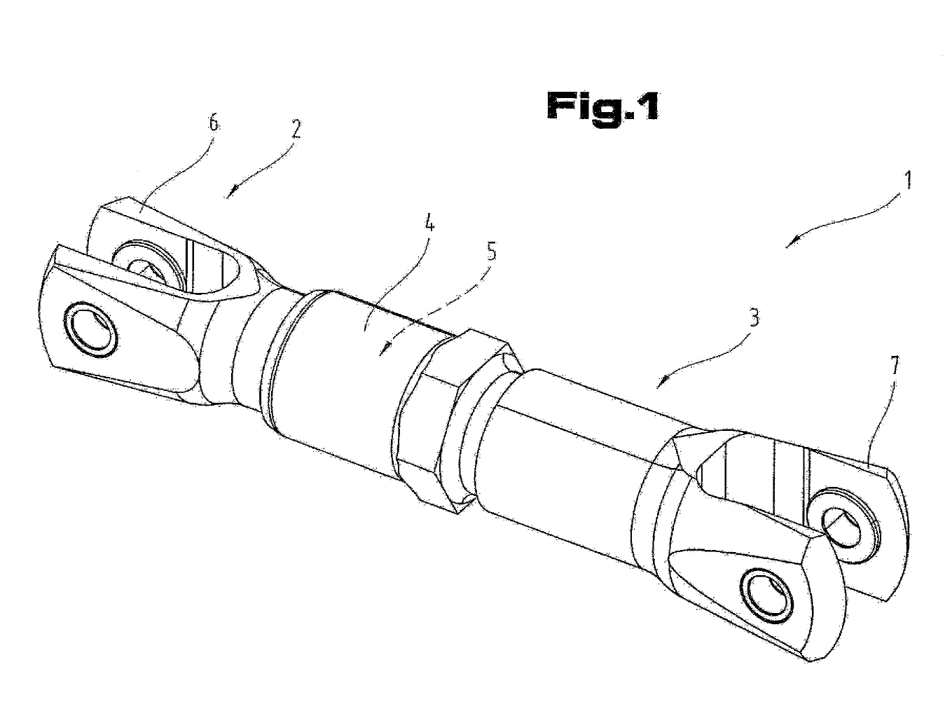

FIG. 1 shows a first possible embodiment of a push-pull rod according to the invention in a diagrammatic illustration;

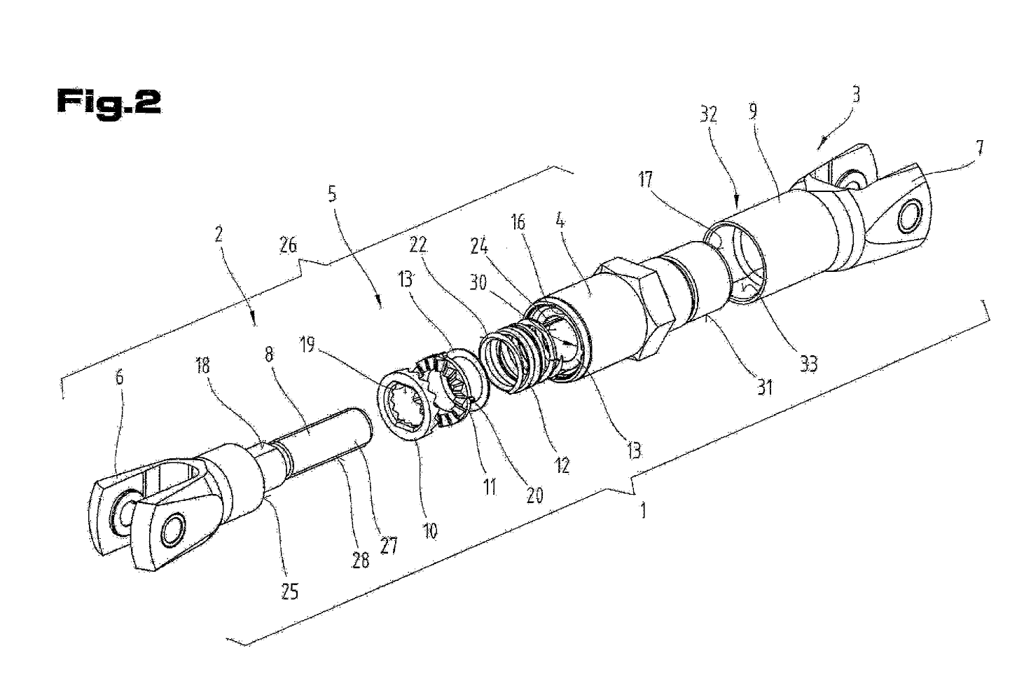

FIG. 2 shows the push-pull rod according to FIG. 1 in the form of an exploded illustration with the individual parts thereof positioned separately from one another in a diagrammatic illustration;

FIG. 3 shows the push-pull rod according to FIGS. 1 and 2 in an axial section;

FIG. 4 shows the push-pull rod in a sectional view as per the line IV-IV in FIG. 3;

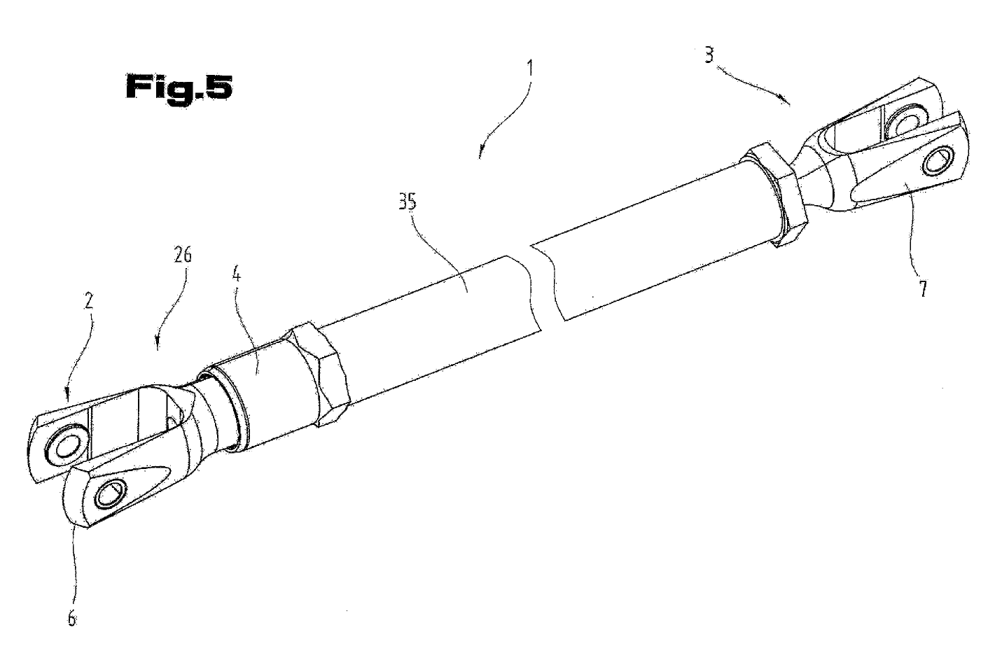

FIG. 5 shows a second possible embodiment of a push-pull rod according to the invention in a diagrammatic illustration;

FIG. 6 shows the push-pull rod as per FIG. 5 in axial section;

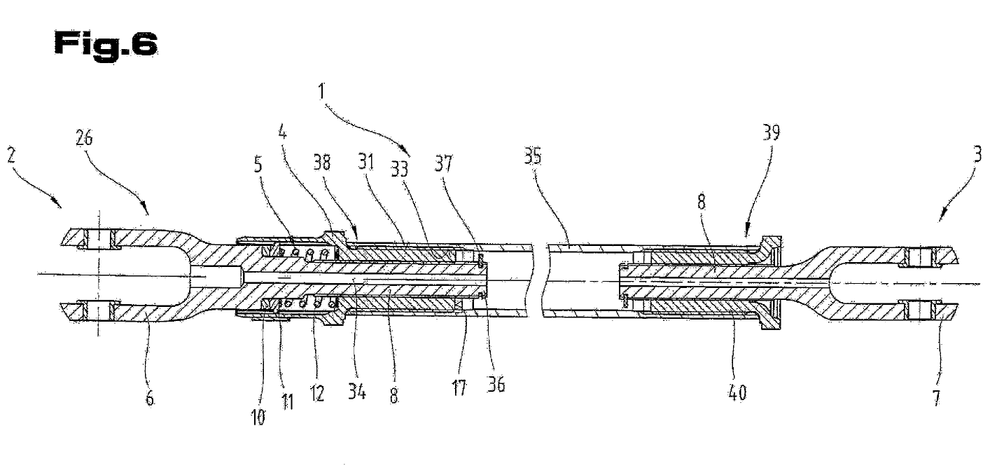

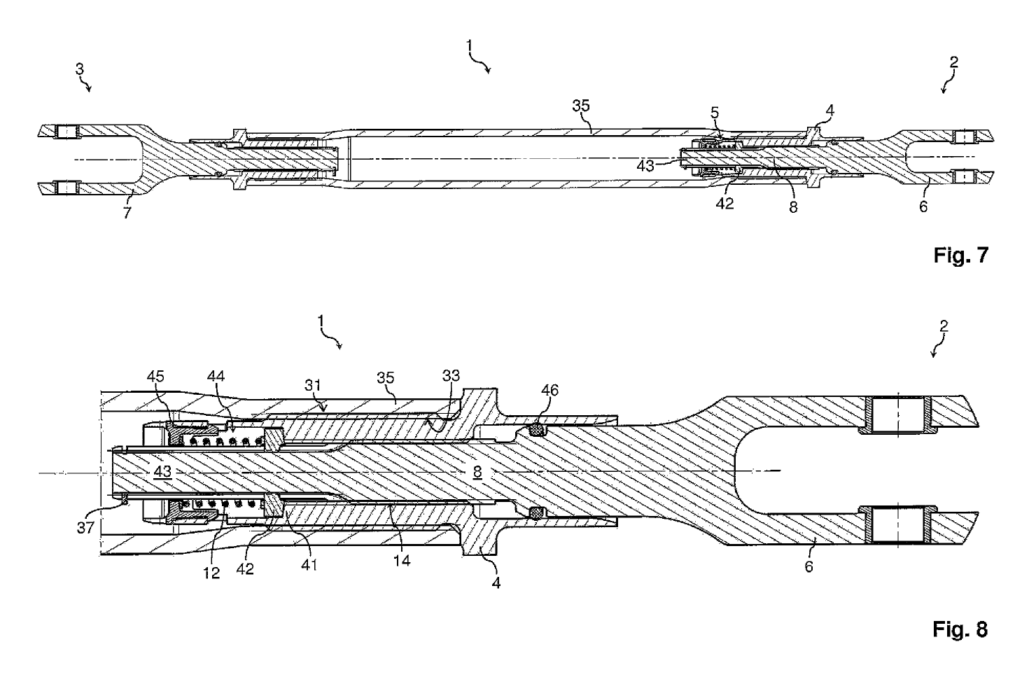

FIG. 7 shows a third possible embodiment of a push-pull rod according to the invention in axial section;

FIG. 8 shows an enlarged detail of the push-pull rod from FIG. 7;

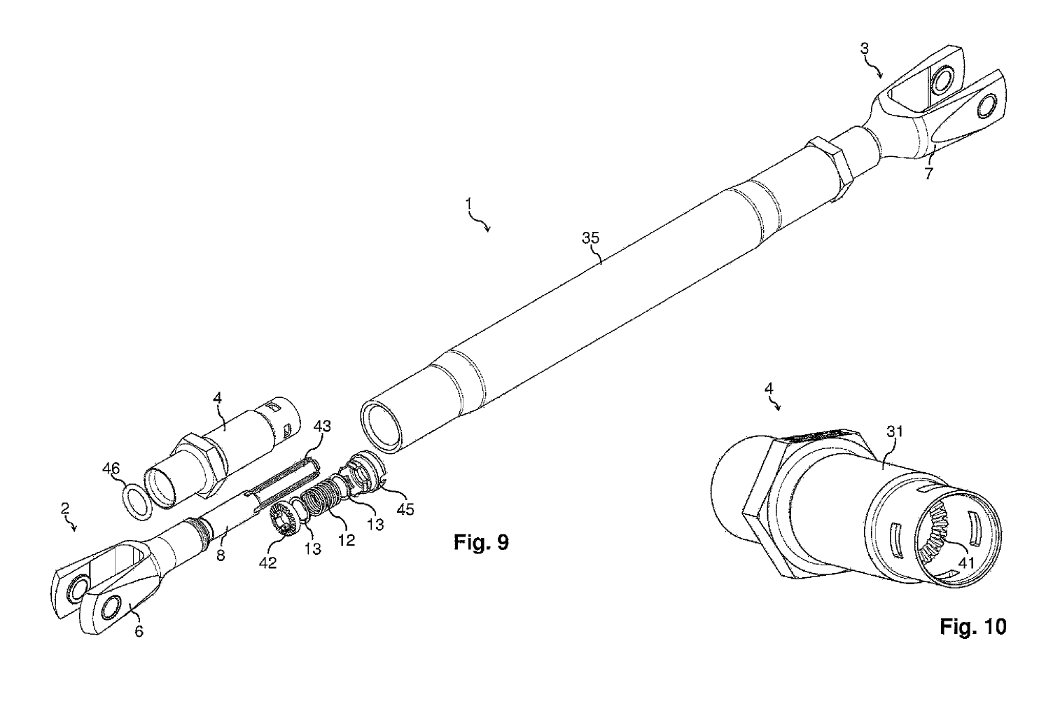

FIG. 9 shows the third possible embodiment of a push-pull rod according to the invention in an exploded illustration;

FIG. 10 shows a connection piece of the push-pull rod illustrated in FIG. 9;

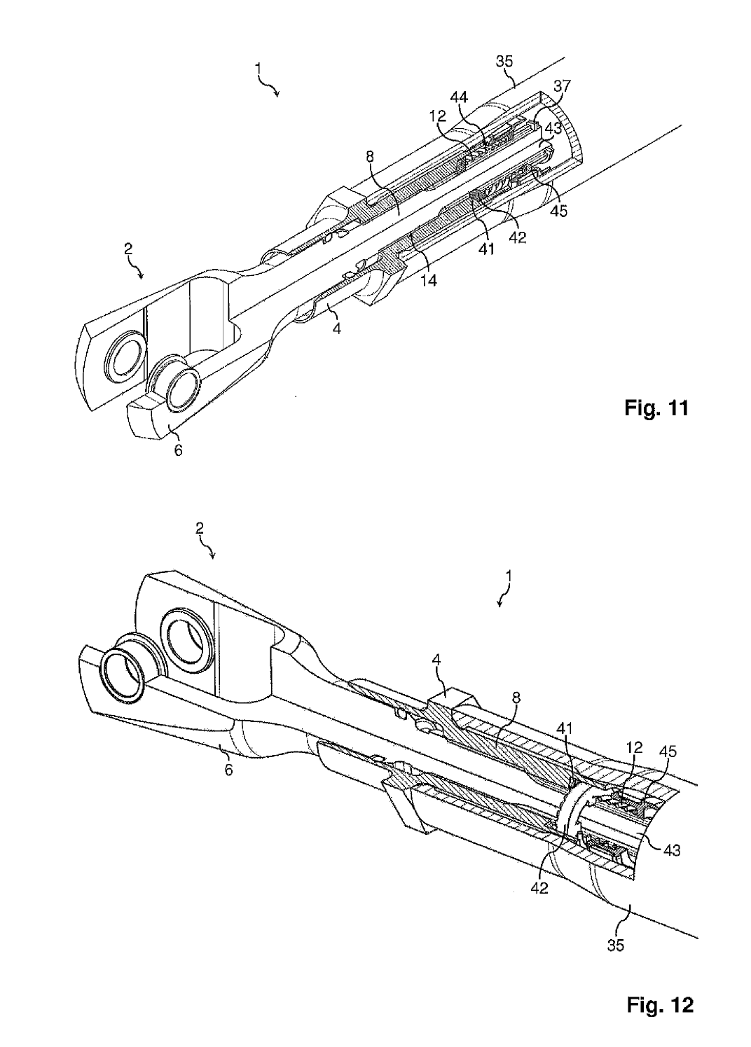

FIG. 11 shows a detail of the third possible embodiment of a push-pull rod according to the invention in quarter section in a first perspective illustration;

FIG. 12 shows a detail of the third possible embodiment of a push-pull rod according to the invention in quarter section in a second perspective illustration;

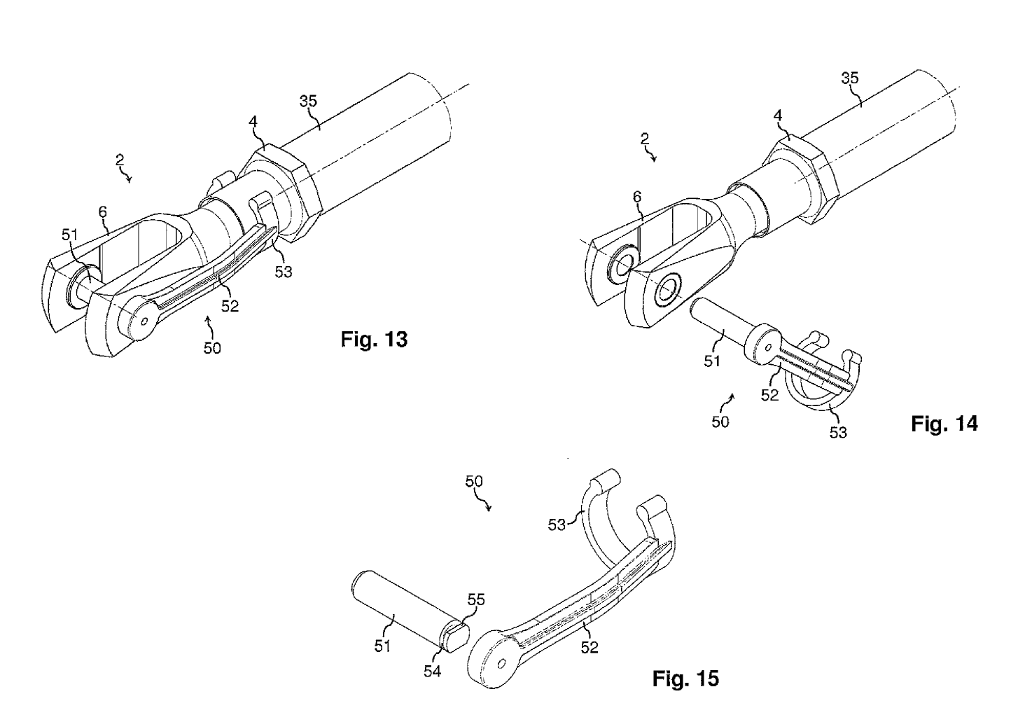

FIG. 13 shows a perspective detail of the third possible embodiment of the push-pull rod according to the invention with the snap-action bolt situated in the latched position;

FIG. 14 shows a perspective detail of the third possible embodiment of the push-pull rod according to the invention with the snap-action bolt released;

FIG. 15 shows a perspective detail view of the snap-action bolt from FIG. 13 and FIG. 14;

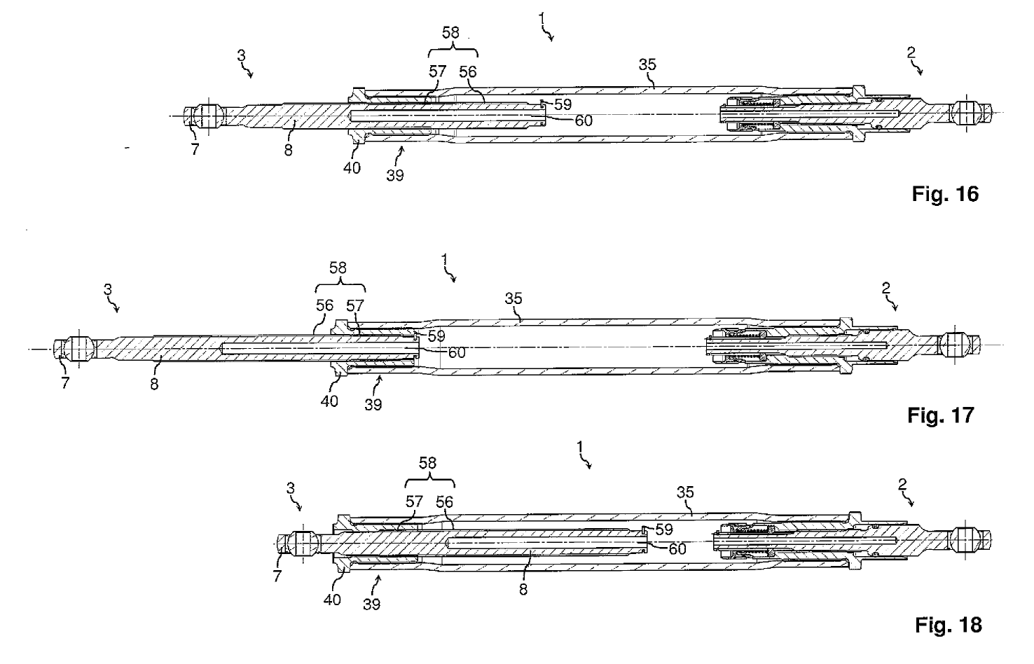

FIG. 16 shows a fourth possible embodiment of a push-pull rod according to the invention in axial section, wherein the further fastening device is situated in a central position;

FIG. 17 shows the push-pull rod as per FIG. 16, with the further fastening device situated in a screwed-out position;

FIG. 18 shows the push-pull rod as per FIG. 16, with the further fastening device situated in a screwed-in position.

By way of introduction, it is stated that, in the different embodiments described, identical parts are denoted by the same reference numerals or the same component designations, wherein the disclosures contained in the description as a whole can be transferred analogously to identical parts with the same reference numerals or the same component designations. Also, the position labels selected in the description, such as for example top, bottom, laterally etc., refer to the figure presently being described, and in the event of a change in position, must be transferred analogously to the new position. Furthermore, individual features or combinations of features from the different exemplary embodiments shown and described may in themselves constitute independent inventive solutions or solutions according to the invention.

All stated value ranges in the present description should be understood as encompassing any and all sub-ranges therein, for example, the statement 1 to 10 should be understood as encompassing all sub-ranges between the lower limit 1 and the upper limit 10, that is to say all sub-ranges beginning at a lower limit of or higher and ending at an upper limit of 10 or lower, for example 1 to 1.7, or 3.2 to 8.1, or 5.5 to 10.

FIGS. 1 to 4 show a first embodiment, which is possibly independent in itself, of a push-pull rod 1 which is of modular design and which comprises in each case one fastening device 2, 3 at the two ends facing away from one another in the axial direction, a connection piece 4 arranged between said fastening devices, and at least one detent device 5.

In the present exemplary embodiment shown here, the push-pull rod 1 has, at both sides, the fastening devices 2, 3 which are at a distance from one another in the axial direction, wherein here, both fastening devices comprise in each case a coupling element 6, 7 and a shank 8, 9 arranged on said coupling element.

The detent device 5 is in turn provided between the first fastening device 2 and the connection piece 4 in order to prevent a relative rotational or pivoting movement of the fastening device 2 with respect to the connection piece 4 after the adjustment of the overall length of the push-pull rod 1. For this purpose, the detent device 5 has detent elements 10, 11 which face toward and interact with one another as viewed in the axial direction and which are pressed against one another or toward one another by means of a spring element 12. At both sides of the spring element 12 there may also be arranged spacers or thrust washers 13 in order to prevent direct contact between the spring element 12 and the detent element 11 or the connection piece 4. Said thrust washer 13 may be produced from a high-grade steel material in order to minimize the friction between the spring element 12 and the detent element 11 or the connection piece 4 in order to prevent direct contact with the spring element 12.

Furthermore, it can be seen most clearly from FIG. 3 that a thread arrangement 14 is provided between the fastening device 2, in particular the shank 8 thereof, and the connection piece 4. A further thread arrangement 15 may also be provided between the shank 9 of the further fastening device 3 and the connection piece 4. To attain an adjustment of the two fastening devices 2, 3 in opposite directions relative to the connection piece 4, one of the two thread arrangements 14, 15 of the connecting piece 4 for connecting to one of the two fastening devices 2, 3 is formed as a right-hand thread, and the other thread arrangement is formed as a left-hand thread. As a result of the thread arrangements 14, 15 formed oppositely to one another, when the two fastening devices 2, 3 are in a coupled position relative to components not illustrated in any more detail here, it is then possible for the length of the push-pull rod 1 to be varied in a simple manner by means of rotation of the connection piece 4 relative to the two fastening devices 2, 3. If both are provided and the thread arrangements 14, 15 have an opposite pitch, it is thus possible to realize a continuously variable adjustment of the distance between the ends of the fastening devices 2, 3. Because the fastening devices 2, 3 are articulatedly connected or coupled to the components to be supported, said fastening devices are held rotationally fixed with respect to the connecting piece 4. As a result of the rotation of the connection piece 4, or of the central part 35 described further below, relative to the fastening devices 2, 3, a certain bracing or preloading is generated between said parts by means of the thread arrangements 14, 15. To facilitate the introduction of the rotational movement into the connection piece 4, an auxiliary element, for example a hexagon or the like, may be arranged on the outside thereof.

The connection piece 4 itself has face ends 16, 17 which are at a distance from one another as viewed in the axial direction and which face toward, and serve in each case for connection to, the two fastening devices 2, 3.

The first detent element 10 of the detent device 5 is itself arranged in a rotationally conjoint manner on the fastening device 2, as can be seen most clearly by viewing FIGS. 2 and 3 together. It is possible for the first detent element 10 either to be an integral constituent part of the fastening device 2, or to be formed by a separate component. It would be possible for the detent element 10 to be formed for example in the manner of a toothed washer which is coupled in a rotationally conjoint manner to the shank 8 of the fastening device 2. By virtue of its being designed as a toothed washer, the first detent element 10 has a central opening which serves for receiving the shank 8. With a corresponding choice of mutual fit, this may range from a clear gap to an interference fit. The rotationally conjoint connection between the first detent element 10 and the shank 8 may for example be realized by virtue of a flattening 18 being arranged on the shank 8, which flattening interacts with a corresponding counterpart surface 19 on the first detent element 10, thus realizing the rotationally conjoint coupling or connection.

Here, the second detent element 11 is likewise in the form of a toothed washer, but is freely rotatable about the shank 8 of the first fastening device 2. To obtain suitable latching of the two detent elements 10 and 11, the second detent element 11 is itself connected in a rotationally conjoint manner to the connection piece 4. For this purpose, the detent element 11 which is formed as a toothed washer has, on its outer end, at least one radially protruding projection 20. Said projection 20 engages into a groove-like recess 21, which extends in the axial direction, in the connection piece 4. It is preferable for a plurality of projections 20, and recesses 21 of identical but opposed design, to be provided over the circumference in order to obtain an improved and more stable transmission of force. Here, the projections 20 and the recesses 21 which interact therewith may be arranged or formed both on the detent element 11 and also on the connection piece 4. The angle of twist between the two detent elements 10, 11 is dependent on the size thereof. If toothed washers are selected, it is possible with small tooth sizes to obtain a virtually continuously variable adjustment, with simultaneous latching-in position, between the two detent elements 10, 11.

Independently of this, however, it would also be possible to provide the detent elements 10, 11 with a friction lining or the like instead of teeth, whereby an even finer adjustment of the overall length of the push-pull rod 1 can be realized. This may likewise be obtained with a type of microstructure on the two surfaces, which face toward one another, of the detent elements 10, 11.

The spring element 20 of the detent device 5 is supported with its first end 22 on a support shoulder 23 formed on the connection piece 4 and with its second end 24 on the second detent element 11. The two interacting detent elements 10, 11 are thus arranged around the shank 8 of the first fastening device 2. The first detent element 10 is supported at one side—because it is formed here by a separate component—on a shoulder 25 of the fastening device 2. As a result of the support of the spring element 20 on the support shoulder 23 and the direction of force thus exerted on the detent elements 10, 11 and, as a further consequence, on the fastening device 2, bracing of the two threads with respect to one another is generated between the shank 8 and the connection piece 4. In this way, noise generation in the event of alternating loads can be reduced or even prevented entirely.

The detent elements 10, 11, which are formed preferably as toothed washers, are arranged in each case independently and in a rotationally conjoint manner on different components of the push-pull rod 1 from one another, and are additionally braced against one another by the spring element 12. At least one of the detent elements—in the present exemplary embodiment the detent element 11—is adjustable in the axial direction with respect to the fastening device 2, as a result of which the detent elements 10, 11 releasably latch the rotational movement of the fastening device 2, 3 relative to the connection piece 4 in a multiplicity of rotational positions with a predetermined locking force.

The connection piece 4, the first fastening device 2 and the detent device 5 form a common and coherent assembly 26. Said coherent assembly 26 may, in this exemplary embodiment, be combined with the further fastening device 3, wherein these together form the complete push-pull rod 1.

The above-described thread arrangement 14 between the connection piece 4 and the first fastening device 2 is formed here such that one thread of the thread arrangement 14 is formed at least on an end portion 27, which is at a distance from the coupling element 6, of the shank 8, and a further thread is formed, on that side of the support shoulder 23 which faces away from the detent device 5, in the connection piece 4. The detent device 5 is in turn arranged between the support shoulder 23 and the coupling element 6 of the first fastening device 4. Here, the thread formed on the shank 8 is formed as an external thread 28. The thread, which interacts therewith, of the connection piece 4 is then formed as an internal thread 29.

The connection piece 4 furthermore has, on the side facing toward the coupling element 6, a receiving space 30 for receiving the detent device 5. The shank 8 thus protrudes through the detent device 5 on the side or in the direction facing away from the first coupling element 6, and extends toward that face end 17 which faces toward the further fastening device 3. To ensure protection of the detent device 5 within the connection piece 4, that face end 16 which faces toward the coupling element 6 of the first fastening device 2 may engage over the detent device 5 in the direction of the coupling element 6. With corresponding dimensional coordination between the end of the coupling element 6 and the receiving space 30, it is possible, if a small spacing is selected, for a rotation of the fastening device 2 relative to the connection piece 4 to take place, but for an infiltration of dirt or the like to be hindered or prevented entirely. It would be possible for a sealing element to be provided in the region of the face end 16 of the connection piece 4.

For the connection of the connection piece 4 in the region of its face end 17 to the further fastening device 3, said connection piece has an external thread 31 on the side facing away from the coupling element 6 of the first fastening device 2.

If the further fastening device 3 is provided in addition to the assembly 26, said further fastening device has an internal thread 33 on its end 32 facing toward the connection piece 4. The external thread 31 thus forms, together with the internal thread 33 which interacts therewith, the further thread arrangement 15. In the present case, the two thread arrangements 14 and 15 may overlap as viewed in the axial direction, wherein the connection piece 4 constitutes the common connecting component. Through the targeted selection of the two thread arrangements 14, 15 and the differing design thereof on the two shanks 8, 9—one as an external thread 28 on the shank 8 and one as an internal thread 33 in the shank 9—it is possible to realize a very short design of the overall push-pull rod 1 in its axial direction.

It can also be seen from FIG. 3 that the fastening device 2, which is a constituent part of the common assembly 26, is extended through in the axial direction by a passage opening 34. Said passage opening serves to allow an unhindered discharge of any water condensation which may form within the push-pull rod 1. Furthermore, the passage opening 34 may also serve for pressure equalization between the interior space and the outside environment and for reducing the weight or the mass of the fastening devices 2, 3.

Furthermore, one thread of the thread arrangement 14 is formed at least on an end portion 27, which is at a distance from the coupling element 6, of the shank 8, and a further thread is formed, on that side of the support shoulder 23 which faces away from the detent device 5, in the connection piece 4, and the detent device 5 is arranged between the support shoulder 23 and the coupling element 6.

Furthermore, the thread of the shank 8 is formed as an external thread 28, and the thread of the connection piece 4 is formed as an internal thread 29.

In addition, the connection piece 4 has, on its side facing toward the coupling element 6, a receiving space 30 for receiving the detent device 5.

Furthermore, the connection piece 4 engages with the face end 16, which faces toward the coupling element 6, over the detent device 5 in the direction of the coupling element 6.

One of the two threads 29, 31 of the connection piece 4 is formed, for connecting to one of the two fastening devices 2, 3, as a right-hand thread, and the other thread 31, 29 is formed as a left-hand thread.

FIGS. 5 and 6 show a further embodiment, possibly independent in itself, of the push-pull rod 1, wherein the same reference numerals or component designations as in the preceding FIGS. 1 to 4 have again been used for identical parts. To avoid unnecessary repetition, reference is made to the detailed description with regard to the preceding FIGS. 1 to 4.

Said push-pull rod 1 illustrated here again has, inter alia, and as a modular component, the common assembly 26 at one end 38. In contrast to the embodiment as per FIGS. 1 to 4, the further fastening device 3 is not connected directly to the external thread 31 of the connection piece 4, but rather a separate central part is provided in order to obtain a greater axial longitudinal extent. Said central part may be of tubular form, wherein the further fastening device 3 is provided on and connected to the further end 39, which faces away from the assembly 26, of the central part 35 of the push-pull rod 1.

The construction and the components of the common assembly 26 correspond exactly to those already described in detail above. Reference is therefore made here, in order to avoid unnecessary repetition, to the detailed description of the preceding FIGS. 1 to 4.

As can be seen most clearly from FIG. 6, the shank 8 of the first fastening device 2 protrudes through that face end 17 of the connection piece 4 which faces away from the coupling element 6. To prevent the fastening device 2 from inadvertently being completely unscrewed from the connection piece 4, at least one radially protruding stop element 37 is arranged on and connected to one shank end 36. Said stop element 37 may be formed for example as a radially resilient lock washer for shafts, which lock washer engages into a shaft groove arranged in the shank 8.

The central part 35, which in this case is of tubular form, has ends 38, 39 which are at a distance from one another as viewed in the axial direction. Here, the common assembly 26 described above is connected to said central part in the region of the first end 38. This is realized preferably by means of a threaded connection, which is additionally secured against inadvertent loosening for example by means of an adhesive. Some other fastening means from the known prior art would however also be possible. This could for example also be realized by means of a positively locking and/or cohesive connection.

An internal thread may likewise be provided in the region of the further end 39 of the central part 35, wherein the further fastening device 3 may either be in direct engagement with said internal thread provided in the central part 35, or else is connected thereto with the interposition of an intermediate piece 40. The intermediate piece 40 may have, on its outer side, an external thread which is in engagement with the internal thread arranged in the region of the end 39. The threaded piece 40 may thus also be referred to as a threaded sleeve if it is provided with an internal thread and with an external thread. It would however also be possible for the intermediate piece 40 to be connected to or mounted on the end 39 of the central part 35 in any other desired way. Positively locking mounting and/or also a cohesive connection, for example by means of an adhesive bead or the like, would for example be conceivable. This is well known from the prior art, and will therefore not be discussed in any more detail.

The two fastening devices 2, 3 with their coupling devices 6, 7 are illustrated here as fork-shaped brackets, wherein these may however also be adapted as desired to the respective connection conditions.

To obtain an elongation or shortening of the entire push-pull rod 1 in opposite directions, it is provided in this embodiment too that, of the thread arrangements of the two fastening devices 2, 3, one is formed by a left-hand thread and one is formed by a right-hand thread.

Furthermore, the shank 8 of the first fastening device 2 protrudes through that face end 17 of the connection piece 4 which faces away from the first coupling element 6, and a radially protruding shank element 37 is arranged on one shank end 36 and connected to the shank 8.

Furthermore, the relative adjustment of the connection piece 4 or of the central part 35 with respect to the two fastening devices 2, 3 can take place in a continuously adjustable fashion.

FIGS. 7 to 12 show a further embodiment, possibly independent in itself, of the push-pull rod 1, wherein the same reference numerals or component designations as in the preceding FIGS. 1 to 6 have again been used for identical parts. To avoid unnecessary repetition, reference is made to the detailed description with regard to the preceding FIGS. 1 to 6.

The push-pull rod 1 illustrated in FIGS. 7 to 12 has a central part 35 and has fastening devices 2, 3 with in each case one coupling element 6 and 7 respectively and with a shank 8 and 9 respectively arranged on said coupling element. The detent device 5 has first and second detent elements 41, 42 which in each case face toward and interact with one another as viewed in the axial direction. The detent elements 41, 42 are pressed against one another by means of a spring element. Here, in contrast to the embodiments described above, the first detent element 41 is connected in a rotationally conjoint manner to the connection piece 4, and the second detent element 42 is arranged in a rotationally conjoint manner on the fastening device 2. The first detent element 41 otherwise substantially corresponds to the detent element 10 described further above, and the second detent element 42 otherwise substantially corresponds to the detent element 11 described above, and said first and second detent elements may in particular be formed as toothed washers.

The shank 8 is connected to the connection piece 4 by means of a thread arrangement 14. Furthermore, the connection piece 4 is connected to the central part 35 by means of a thread arrangement composed of the internal thread 33 and the corresponding external thread 31. Aside from this, the connection piece 4 has, on its side facing away from the coupling element 6, a receiving space 44. Said receiving space 44 serves to receive the detent device 5. At its side facing away from the coupling element 6, the receiving space 44 is delimited by a support shoulder 23, which is formed as a support ring 45, for supporting the first end of the spring element 12. In the embodiment illustrated in FIGS. 7 to 12, the spring element 12 is thus supported with its first end 22 on the support ring 45 and with its second end 24 on the second detent element 42. The detent elements 41, 42 in this way releasably latch the rotational movement of the fastening device 2 relative to the connection piece 4 in a multiplicity of rotational positions with a predetermined locking force.

The shank 8 has a profiled shank projection 43 on its side facing away from the coupling element 6. In the present exemplary embodiment, the profiling is formed as a groove in the shank projection. Furthermore, the second detent element 42 is of annular design and has a through hole, the geometry of which is coordinated with the profiling of the shank projection 43 such that the second detent element 42 is mounted in a rotationally conjoint but axially displaceable manner on the connection piece 6.

The support ring 45 is connected by means of a snap-action connection to that axial end region of the connection piece 4 which faces away from the coupling element 6. Here, the shank projection 43 projects through the support ring 45, wherein the circular internal opening of the support ring 45 has a diameter which permits free mobility of the support ring in the axial direction along the shank projection 43.

The first detent element 41 is in one piece with the connection piece 4 and forms an internal shaft shoulder of the connection piece 4. As is illustrated in particular in FIG. 10, said internal shaft shoulder of the connection piece 4 is provided with teeth, such that an interaction of the two detent elements 41, 42 causes the rotational movement of the fastening device 2 relative to the connection piece 4 to be releasably latched in a multiplicity of rotational positions with a predetermined locking force.

The profiled shank projection 43 projects through the receiving space 44 of the connection piece 4, and a radially protruding stop element 37 is arranged on the shank end 36 of the shank 8. Furthermore, a seal 46 in the form of a sealing ring is arranged between the coupling element 6 and the connection element 4.

FIG. 13 shows a perspective detail of the third possible embodiment of the push-pull rod according to the invention, with a snap-action bolt 50 situated in the latched position. The snap-action bolt 50 is composed of a pin 51, a lever arm 52 and a snap-action ring 53. The pin is inserted into the eyelets of the coupling element 6. The snap-action ring 53 is placed around the outer circumference of the connection piece 4. As a result of the snapping-on of the snap-action ring 53, the bolt 51 is secured such that a release of the bolt 51 from the eyelets of the coupling element 6 is reliably prevented. The pin 51 is composed of metal, in particular of a high-grade steel material. The lever arm 52 and the snap-action ring 53 are produced from a plastic, in particular from polyamide. Here, the lever arm 52 and the snap-action ring 53 are advantageously produced in one piece.

FIG. 14 shows the snap-action bolt 50 in a released position, that is to say the bolt 51 is not inserted into eyelets of the coupling element 6 and the snap-action ring 53 is not placed around the connection piece 4.

FIG. 15 shows a perspective detail view of the snap-action bolt 50. The lever arm 52 and the snap-action ring 53 are formed in one piece. The bolt 51 may, in order to be connected to the lever arm 52, be inserted with one of its axial ends into a depression of the lever arm 52. The depression of the lever arm 52 is not illustrated in the figures. The connection between the bolt 51 and lever arm 52 is realized in particular by means of an undercut 54 which is formed on the bolt 51 and which, when the bolt is inserted into the corresponding depression of the lever arm 52, allows a positively locking connection to be formed between the bolt 51 and the lever arm 52. Both the undercut 54 and also the flattening 55 are formed in one axial end region of the bolt 51. Furthermore, a flattening 55 is formed on the bolt 51. After the bolt 51 is inserted into the depression of the lever arm 52, said flattening 55 corresponds with a correspondingly shaped counterpart formation, such that a rotation of the bolt 51 relative to the lever arm 52 is reliably prevented, and a rotationally conjoint connection is thus formed.

FIGS. 16 to 18 show a further embodiment of the push-pull rod 1 with a first fastening device 2, a central part 35 and a further fastening device 3. Here, the fastening device 2 corresponds to that which has already been described in detail with regard to FIGS. 6 to 12. To avoid repetitions, reference is therefore made to those passages of this description which relate thereto.

The further fastening device 3 has a second coupling element 7 and a shank 8. Both the shank 8 of the further fastening device 8 and also the shank (not shown in any more detail in FIGS. 16 to 18) of the first fastening device have an internal bore 60 which extends along the axial direction of the push-pull rod 1.

The further fastening device 3 is connected, with the interposition of an intermediate piece 40, to one end 39 of the central part 35. An external thread 56 is formed on that end of the fastening device 3 which faces toward the intermediate piece 40. Said external thread 56 is rotatably connected to an internal thread 57 formed on the intermediate piece 40, such that the two threads 56, 57 form a further thread arrangement 58. Here, the external thread 56 is formed on the lateral surface of the shank 8 of the further fastening device 3.

The external thread 56 of the further fastening device 3 is formed along the further fastening device 3 in the axial direction of the push-pull rod 1 over a region longer than that over which the thread arrangement 14 is formed along the first fastening device 2. Also, the further fastening device 3 is formed so as to be longer in the axial direction of the push-pull rod 1 than the first fastening device 2.

Furthermore, the shank 8 of the further fastening device 3 protrudes through that face end of the intermediate piece 40 which faces away from the second coupling element 7. A radially protruding stop element is arranged on that shank end through which the intermediate piece 40 protrudes, which stop element is connected to the shank 8.

FIG. 16 shows the further fastening device 3 in a central position. In said central position, it is possible both for the second coupling element 7 to be screwed in by rotating the thread arrangement 58 in a first direction of rotation, and also for the coupling element 7 to be screwed out by rotating the thread arrangement 58 in a second direction of rotation which opposes the first direction of rotation. FIG. 17 shows the push-pull rod 1 in a screwed-out position. Here, the further fastening device 3 has been screwed out of the central part 35 by means of the thread arrangement 58 to such an extent that the stop element 59 makes contact with the end side of the intermediate piece 40. FIG. 18 shows the push-pull rod 1 in a screwed-in position. Here, the further fastening device 3 has been screwed into the central part 35 as far as is permitted by the thread arrangement 58.

The exemplary embodiments show possible design variants of the push-pull rod 1 or of the common assembly 26, wherein it is pointed out at this juncture that the invention is not restricted to the design variants thereof that are specifically illustrated, but that, rather, various combinations of the individual design variants with one another are also possible and this possibility for variation on the basis of the teaching for technical action that is provided by the present invention is within the ability of a person skilled in the art engaged in this technical field. The scope of protection thus also encompasses all conceivable design variants which are possible through combinations of individual details of the design variant illustrated and described.

As a matter of form, it is finally pointed out that, for better understanding of the construction of the push-pull rod 1 or of the common assembly 26, these or the constituent parts thereof have in part been shown not to scale and/or have been shown enlarged and/or reduced in size.

The object underlying the independent solutions according to the invention may be gathered from the description.

Above all, the individual designs shown in FIGS. 1 to 18 may form the subject matter of independent solutions according to the invention.

The relevant problems and solutions according to the invention emerge from the detailed descriptions of said figures.

### LIST OF REFERENCE NUMERALS

1 Push-pull rod
2 Fastening device
3 Fastening device
4 Connection piece
5 Detent device
6 Coupling element
7 Coupling element
8 Shank
9 Shank
10 Detent element
11 Detent element
12 Detent element
13 Thrust washer
14 Thread arrangement
15 Thread arrangement
16 Face end
17 Face end
18 Flattening
19 Counterpart surface
20 Projection
21 Recess
22 End
23 Support shoulder
24 End
25 Shoulder
26 Assembly
27 End portion
28 External thread
29 Internal thread
30 Receiving space
31 External thread
32 End
33 Internal thread
34 Passage opening
35 Central part
36 Shank end
37 Stop element
38 End
39 End
40 Intermediate piece
41 Detent element
42 Detent element
43 Shank projection
44 Receiving space
45 Support ring
46 Seal
50 Snap-action bolt
51 Pin
52 Lever arm
53 Snap-action ring
54 Undercut
55 Flattening
56 External thread
57 Internal thread
58 Thread arrangement
59 Stop element
60 Bore

1. A push-pull rod (1) comprising at least one fastening device (2, 3) with a coupling element (6, 7) and with a shank (8, 9) arranged on said coupling element, at least one connection piece (4) with face ends (16, 17) at a distance from one another in an axial direction, wherein, for variation of the length of the push-pull rod (1), the fastening device (2, 3) is rotatably connected via a thread arrangement (14, 15) to the connection piece (4), a detent device (5) having first and second detent elements (10, 11) which in each case face toward and interact with one another as viewed in the axial direction and which are pressed against one another by means of a spring element (12), wherein the first detent element (10) of the detent device (5) is arranged in a rotationally conjoint manner on the fastening device (2) and the second detent element (11) is connected in a rotationally conjoint manner to the connection piece (4), wherein the spring element (12) is supported with its first end (22) on a support shoulder (23) formed on the connection piece (4) and with its second end (24) on the second detent element (11), and here, the detent elements (10, 11) releasably latch the rotational movement of the fastening device (2) relative to the connecting piece (4) in a multiplicity of rotational positions with a predetermined locking force.

2. A push-pull rod (1) comprising at least one fastening device (2, 3) with a coupling element (6, 7) and with a shank (8, 9) arranged on said coupling element, at least one connection piece (4) with face ends (16, 17) at a distance from one another in an axial direction, wherein, for variation of the length of the push-pull rod (1), the fastening device (2, 3) is rotatably connected via a thread arrangement (14, 15) to the connection piece (4), a detent device (5) having first and second detent elements (41, 42) which in each case face toward and interact with one another as viewed in the axial direction and which are pressed against one another by means of a spring element (12), wherein the first detent element (41) of the detent device (5) is connected in a rotationally conjoint manner to the connection piece (4) and the second detent element (42) is arranged in a rotationally conjoint manner on the fastening device (2), wherein the spring element (12) is supported with its first end (22) on a support shoulder (23) formed on the connection piece (4) and with its second end (24) on the second detent element (42), and here, the detent elements (41, 42) releasably latch the rotational movement of the fastening device (2) relative to the connecting piece (4) in a multiplicity of rotational positions with a predetermined locking force.

3. The push-pull rod (1) as claimed in claim 1, wherein the first detent element (10) is in the form of a toothed washer which is coupled in a rotationally conjoint manner to the shank (8) of the fastening device (2).

4. The push-pull rod (1) as claimed in claim 1, wherein the second detent element (11) is in the form of a toothed washer which is freely rotatable about the shank (8) of the fastening device (2).

5. The push-pull rod (1) as claimed in claim 1, wherein the second detent element (11) which is in the form of a toothed washer has, on its outer circumference, at least one radially protruding projection (20) which engages into a groove-like recess (21), which extends in the axial direction, in the connection piece (4).

6. The push-pull rod (1) as claimed in claim 1, wherein the connection piece (4) is provided with an external thread (31) on the side facing away from the coupling element (6).

7. The push-pull rod (1) as claimed in claim 1, wherein it comprises a further fastening device (3), wherein the further fastening device (3) has, on its end (32) facing toward the connection piece (4), an internal thread (33) which is rotatably connected to the external thread (31) formed on the connection piece (4), and the two threads (31, 33) form a further thread arrangement (15).

8. The push-pull rod (1) as claimed in claim 1, wherein it furthermore comprises a central part (35) with ends (38, 39) at a distance from one another in the axial direction, wherein the common assembly (26) is connected to one end (38) of the central part (35), and a further fastening device (3) is connected to the other end (39).

9. The push-pull rod (1) as claimed in claim 8, wherein the further fastening device (3) is connected, with the interposition of an intermediate piece (40), to the other end (39) of the central part (35).

10. The push-pull rod (1) as claimed in claim 9, wherein the further fastening device (3) has, on its end facing toward the intermediate piece (40), an external thread (56) which is rotatably connected to an internal thread (57) formed on the intermediate piece (40), and the two threads (56, 57) form a further thread arrangement (58).

11. The push-pull rod (1) as claimed in claim 10, wherein the external thread (56) is formed on a shank (8) of the further fastening device (3).

12. The push-pull rod (1) as claimed in claim 10, wherein the external thread (56) of the further fastening device (3) is formed along the further fastening device (3) in the axial direction of the push-pull rod (1) over a region longer than that over which the thread arrangement (14) is formed along the first fastening device (2).

13. The push-pull rod (1) as claimed in claim 10, wherein the further fastening device (3) is formed so as to be longer in the axial direction of the push-pull rod (1) than the first fastening device (2).

14. The push-pull rod (1) as claimed in claim 1, wherein the shank (8) of the first fastening device (2) protrudes through that face end (17) of the connection piece (4) which faces away from the first coupling element (6), and at least one radially protruding stop element (37) is arranged on one shank end (36) and connected to the shank (8).

15. The push-pull rod (1) as claimed in claim 8, wherein the shank (8) of the further fastening device (3) protrudes through that face end of the intermediate piece (40) which faces away from the second coupling element (7), and at least one radially projecting stop element (59) is arranged on one shank end and connected to the shank (8).

16. The push-pull rod (1) as claimed in claim 2, wherein the connection piece (4) has, on its side facing away from the coupling element (6), a receiving space (44) which serves for receiving the detent device (5) and which is delimited, on its side facing away from the coupling element (6), by a support shoulder, which is formed as a support ring (45), for supporting the first end of the spring element (12).

17. The push-pull rod (1) as claimed in claim 2, wherein the shank (8) has, on its side facing away from the coupling element (6), a profiled shank projection (43), by means of the profiling of which the second detent element (42) is mounted in a rotationally conjoint and axially displaceable manner on the connection piece (6).

18. The push-pull rod (1) as claimed in claim 2, wherein the shank (8), in particular the profiled shank projection (43), protrudes through the receiving space (44) of the connection piece (4), and at least one radially projecting stop element (37) is arranged on the shank end (36) of said shank.

19. The push-pull rod (1) as claimed in claim 2, wherein the first detent element (41) is formed in one piece with the connection piece (4), in particular as an internal shaft shoulder.

20. The push-pull rod (1) as claimed in claim 2, wherein the support ring (45) is connected by means of an adhesive or snap-action connection to that axial end region of the connection piece (4) which faces away from the coupling element (6).

21. The push-pull rod (1) as claimed in claim 1, having a snap-action bolt (50) which can be attached to the coupling element (6, 7) and which has a metallic pin (51) and which also has a lever arm (52) and snap-action ring (53) composed in each case of plastic, in particular polyamide.

22. The push-pull rod (1) as claimed in claim 21, wherein the pin (51) has, on one of its axial end regions, an undercut (54) and a flattening (55).

23. The push-pull rod as claimed in claim 1, wherein the shank (8) of the first fastening device (2) and/or the shank of the further fastening device (3) has an internal bore (60) which extends along the axial direction of the push-pull rod (1).
